(19) United States
(12) Patent Application Publication
(10) Pub. No.: US 2022/0006914 A1
(43) Pub. Date: Jan. 6, 2022

(54) AUTOMATIC DOCUMENT FEEDER WITH DISENGAGEABLE ROLLERS

(71) Applicant: Hewlett-Packard Development Company, L.P., Spring, TX (US)

(72) Inventors: Rene O. Valenzuela-Rivas, San Diego, CA (US); Ryan M. Smith, San Diego, CA (US)

(73) Assignee: Hewlett-Packard Development Company, L.P., Spring, TX (US)

(21) Appl. No.: 17/298,612

(22) PCT Filed: Jul. 31, 2019
(86) PCT No.: PCT/US2019/044455

§ 371 Date: May 31, 2021

(51) Int. Cl. H04N 1/00; B41J 13/00; B65H 5/06; B65H 1/04

(52) U.S. Cl. CPC H04N 1/00602; B41J 13/0018; B65H 2801/06; B65H 5/06; B65H 1/04; B41J 13/0036

(57) ABSTRACT

An automatic document feeder includes a media path to route media through the automatic document feeder, an opposing roller pair to route media along the media path, and a media tray to receive the media from the media path, the media tray to be opened, and the opposing roller pair to be disengaged when the media tray is opened.

### BACKGROUND

An automatic document feeder may be used for automatically transporting a sheet of media to an imaging or scanning position for copying, scanning, faxing, displaying on a monitor, or other processing. Thereafter, the automatic document feeder may eject the media and process a next sheet of media.

### BRIEF DESCRIPTION OF THE DRAWINGS

FIGS. 1A and 1B are block diagrams illustrating an example of an automatic document feeder including disengagement of opposing roller pairs of the automatic document feeder.

FIG. 2 is a block diagram illustrating an example of an inkjet printing system including an example of an automatic document feeder.

FIGS. 3A and 3B are perspective views illustrating an example of an automatic document feeder including opening of a media tray of the automatic document feeder.

FIGS. 4A and 4B are cross-sectional views illustrating an example of the automatic document feeder of FIGS. 3A and 3B including disengagement of opposing roller pairs of the automatic document feeder with the opening of the media tray of the automatic document feeder.

FIGS. 5A and 5B are cross-sectional views illustrating another example of an automatic document feeder including opening of a media tray of the automatic document feeder and disengagement of opposing roller pairs of the automatic document feeder with the opening of the media tray of the automatic document feeder.

FIG. 6 is a flow diagram illustrating an example of a method of disengaging rollers of an automatic document feeder.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure.

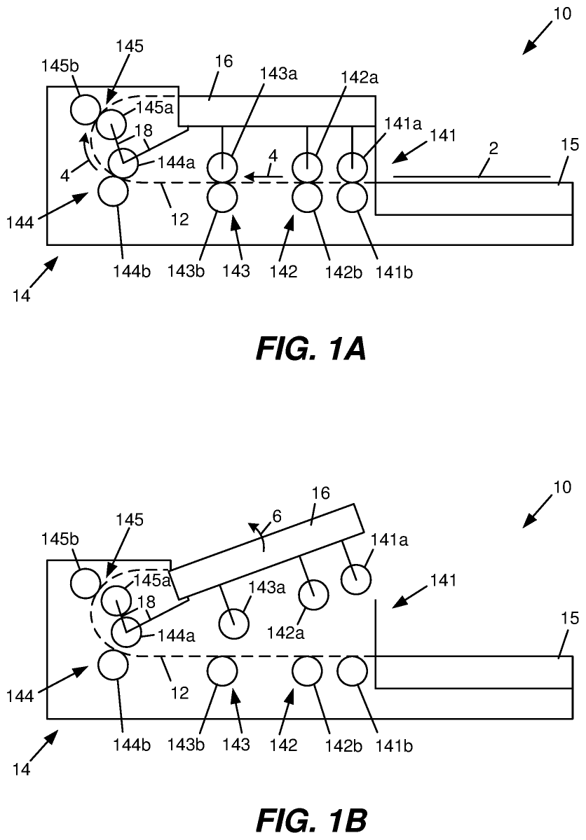

As illustrated in the example of FIGS. 1A and 1B, the present disclosure provides an automatic document feeder (ADF) 10. In one implementation, ADF 10 includes a media path 12 to route media 2 through ADF 10, as represented by arrows 4, an opposing roller pair 14 to route media along media path 12, and a media tray 16 to receive media 2 from media path 12. In examples, media tray 16 is to be opened, and opposing roller pair 14 is to be disengaged when media tray 16 is opened.

In examples, opposing roller pair 14 includes multiple opposing pairs of rollers to route media along media path 12. In examples, opposing roller pair 14 comprises a pick roller pair 141, including rollers 141a, 141b. In examples, opposing roller pair 14 comprises a separation roller pair 142, including rollers 142a, 142b. In examples, opposing roller pair 14 comprises a pre-scan roller pair 143, including rollers 143a, 143b. In examples, opposing roller pair 14 comprises a post-scan roller pair 144, including rollers 144a, 144b. In examples, opposing roller pair 14 comprises an exit roller pair 145, including rollers 145a, 145b.

In implementations, media tray 16 supports a roller of opposing roller pair 14, and media tray 16 is rotated to be opened, as represented, for example, by arrow 6, such that media tray 16 disengages a roller of opposing roller pair 14 from another roller of opposing roller pair 14 when media tray 16 is rotated. For example, in implementations, media tray 16 supports roller 141a of pick roller pair 141 such that media tray 16 disengages roller 141a of pick roller pair 141 from roller 141b of pick roller pair 141 when media tray 16 is rotated. For example, in implementations, media tray 16 supports roller 142a of separation roller pair 142 such that media tray 16 disengages roller 142a of separation roller pair 142 from roller 142b of separation roller pair 142 when media tray 16 is rotated. For example, in implementations, media tray 16 supports roller 143a of pre-scan roller pair 143 such that media tray 16 disengages roller 143a of pre-scan roller pair 143 from roller 143b of pre-scan roller pair 143 when media tray 16 is rotated.

In implementations, ADF 10 includes a linkage 18 extended between media tray 16 and a roller of opposing roller pair 14, and media tray 16 is rotated to be opened, as represented, for example, by arrow 6, such that linkage 18 disengages a roller of opposing roller pair 14 from another roller of opposing roller pair 14 when media tray 16 is rotated. For example, in implementations, linkage 18 extends between media tray 16 and roller 144a of post-scan roller pair 144, such that linkage 18 disengages roller 144a of post-scan roller pair 144 from roller 144b of post-scan roller pair 144 when media tray 16 is rotated. For example, in implementations, linkage 18 extends between media tray 16 and roller 145a of exit roller pair 145, such that linkage 18 disengages roller 145a of exit roller pair 145 from roller 145b of exit roller pair 145 when media tray 16 is rotated.

As disclosed herein, an automatic document feeder, such as ADF 10, may be used to automatically transport media (one sheet or multiple sheets sequentially) along a media path, such as media path 12, from an input tray, such as media tray 15, to a scanning or imaging position, and then to an output tray, as an example of media tray 16. At the scanning or imaging position, the media may be scanned or imaged for copying, scanning, faxing, displaying on a monitor, or other processing. In examples, ADF 10 may be part of a printer, a scanner, a photocopier, a fax machine, or a multi-function or all-in-one device providing printing, scanning, copying, and/or faxing capabilities.

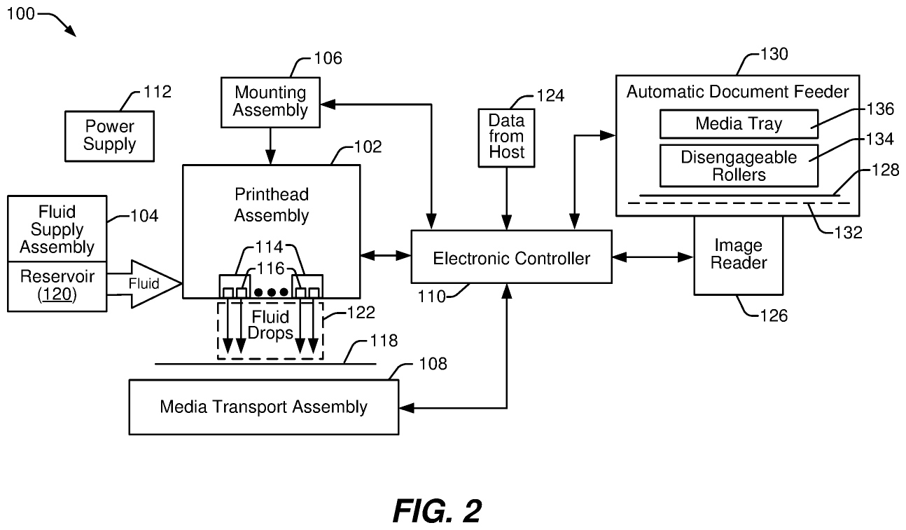

FIG. 2 illustrates an example of an inkjet printing system. Inkjet printing system 100 includes a printhead assembly 102, as an example of a fluid ejection assembly, a fluid (e.g., ink) supply assembly 104, a mounting assembly 106, a media transport assembly 108, an electronic controller 110, and a power supply 112 that provides power to electrical components of inkjet printing system 100. Printhead assembly 102 includes a printhead die 114, as an example of a fluid ejection die or fluid ejection device, that ejects drops of fluid through a plurality of orifices or nozzles 116 toward a print media 118 so as to print on print media 118.

Print media 118 can be any type of suitable sheet or roll material, such as paper, card stock, transparencies, Mylar, and the like, and may include rigid or semi-rigid material, such as cardboard or other panels. Nozzles 116 are arranged in columns or arrays such that properly sequenced ejection of fluid from nozzles 116 causes characters, symbols, and/or other graphics or images to be printed on print media 118 as printhead assembly 102 and print media 118 are moved relative to each other.

Fluid supply assembly 104 supplies fluid to printhead assembly 102 and, in one example, includes a reservoir 120 for storing fluid such that fluid flows from reservoir 120 to printhead assembly 102. In one example, printhead assembly 102 and fluid supply assembly 104 are housed together in an inkjet cartridge or pen. In another example, fluid supply assembly 104 is separate from printhead assembly 102 and supplies fluid to printhead assembly 102 through an interface connection, such as a supply tube.

Mounting assembly 106 positions printhead assembly 102 relative to media transport assembly 108, and media transport assembly 108 positions print media 118 relative to printhead assembly 102. Thus, a print zone 122 is defined adjacent to nozzles 116 in an area between printhead assembly 102 and print media 118. In one example, printhead assembly 102 is a scanning type printhead assembly. As such, mounting assembly 106 includes a carriage for moving printhead assembly 102 relative to media transport assembly 108 to scan print media 118. In another example, printhead assembly 102 is a non-scanning type printhead assembly. As such, mounting assembly 106 fixes printhead assembly 102 at a prescribed position relative to media transport assembly 108. Thus, media transport assembly 108 positions print media 118 relative to printhead assembly 102.

Electronic controller 110 includes a processor, firmware, software, memory components including volatile and non-volatile memory components, and other printer electronics for communicating with and controlling printhead assembly 102, mounting assembly 106, and media transport assembly 108. Electronic controller 110 receives data 124 from a host system, such as a computer, and temporarily stores data 124 in a memory. Data 124 is sent to inkjet printing system 100 along an electronic, infrared, optical, or other information transfer path. Data 124 represents, for example, a document and/or file to be printed. As such, data 124 forms a print job for inkjet printing system 100 and includes print job commands and/or command parameters.

In one example, electronic controller 110 controls printhead assembly 102 for ejection of fluid drops from nozzles 116. Thus, electronic controller 110 defines a pattern of ejected fluid drops which form characters, symbols, and/or other graphics or images on print media 118. The pattern of ejected fluid drops is determined by the print job commands and/or command parameters.

Printhead assembly 102 includes one (i.e., a single) printhead die 114 or more than one (i.e., multiple) printhead die 114. In one example, printhead assembly 102 is a wide-array or multi-head printhead assembly. In one implementation of a wide-array assembly, printhead assembly 102 includes a carrier that carries a plurality of printhead dies 114, provides electrical communication between printhead dies 114 and electronic controller 110, and provides fluidic communication between printhead dies 114 and fluid supply assembly 104.

In one example, inkjet printing system 100 is a drop-on-demand thermal inkjet printing system wherein printhead assembly 102 includes a thermal inkjet (TIJ) printhead that implements a thermal resistor as a drop ejecting element to vaporize fluid in a fluid chamber and create bubbles that force fluid drops out of nozzles 116. In another example, inkjet printing system 100 is a drop-on-demand piezoelectric inkjet printing system wherein printhead assembly 102 includes a piezoelectric inkjet (PIJ) printhead that implements a piezoelectric actuator as a drop ejecting element to generate pressure pulses that force fluid drops out of nozzles 116.

In examples, inkjet printing system 100 includes an automatic document feeder (ADF) 130, as an example of ADF 10, and an image reader 126 such that ADF 130 automatically transports media 128, as an example of media 2, along a media path 132, as an example of media path 12, to and/or past image reader 126. As such, image reader 126 may acquire and/or generate an image of a side or surface of media 128.

In one implementation, ADF 130 includes disengageable rollers 134, as an example of opposing roller pair 14, to route media along media path 132, and includes a media tray 136, as an example of media tray 16, to receive media 128 as output from media path 132 (e.g., an output tray). In examples, as disclosed herein, media tray 136 is to be opened, and disengageable rollers 134 are to be disengaged (separated, spaced, opened, de-pinched) when media tray 136 is opened.

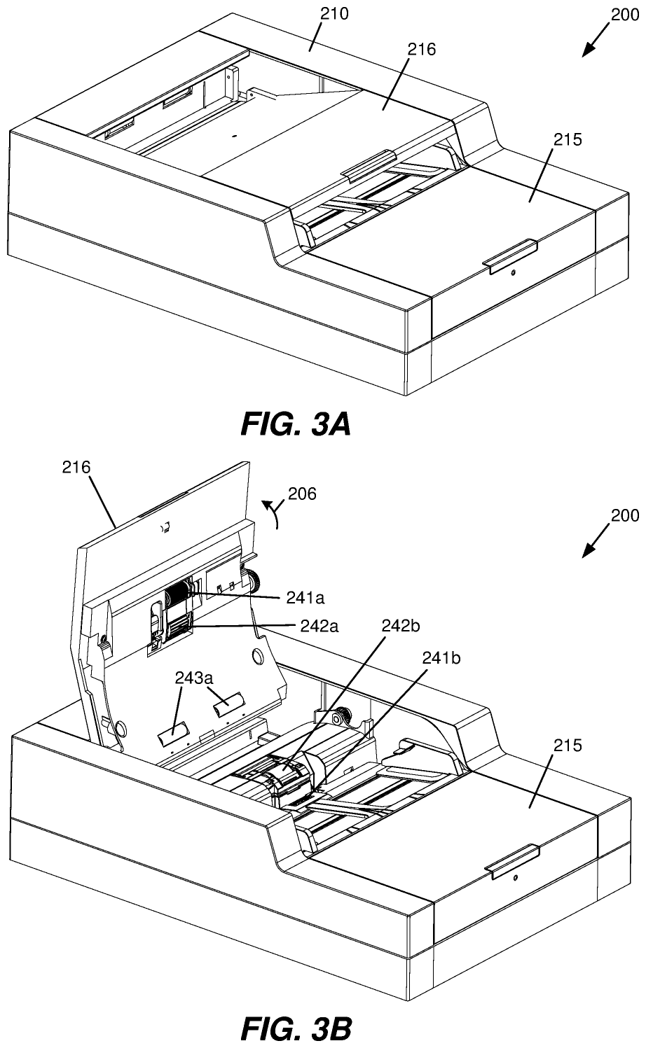

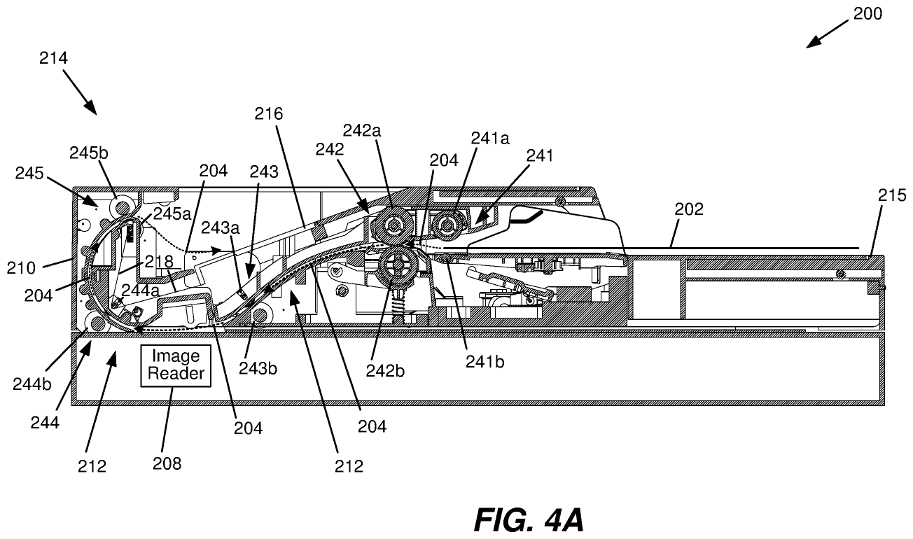

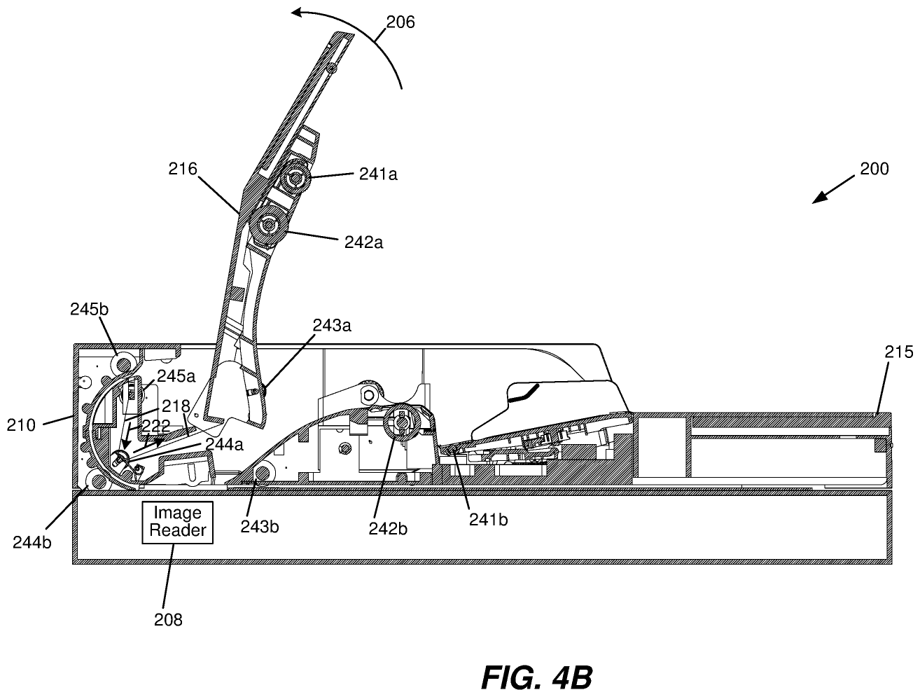

FIGS. 3A and 3B are perspective views illustrating an example of an automatic document feeder (ADF) 200, as an example of ADF 10, 130, including opening of a media tray 216 of ADF 200, as an example of media tray 16, 136, and FIGS. 4A and 4B are cross-sectional views illustrating an example of ADF 200 including disengagement of opposing roller pairs 214 of ADF 200, as an example of opposing roller pair 14, and disengageable rollers 134, with the opening of media tray 216. In implementations, as disclosed herein, media tray 216 is rotated to be opened, as represented, for example, by arrow 206 and illustrated in the example of FIGS. 3B, 4B, such that media tray 216 disengages a roller of opposing roller pair 214 from another roller of opposing roller pair 214 when media tray 216 is rotated.

As illustrated in the example of FIGS. 3A and 3B, 4A and 4B, ADF 200 includes a housing 210, media tray 216 supported by housing 210, and a media path 212, as an example of media path 12, 132, within housing 210 to route media through ADF 200, such as media 202, as an example of media 2, 128. In one example, media tray 216 is an output tray and receives and supports media as output from ADF 200. As such, in one example, ADF 200 includes an input tray 215 that supports and supplies media, such as media 202, for input to ADF 200. Accordingly, as illustrated in the example of FIG. 4A, input tray 215 communicates with one end of media path 212 (i.e., an input end), and media tray 216 communicates with an opposite end of media path 212 (i.e., an output end). As such, media 202 may be routed from input tray 215 to media tray 216 along media path 212, as represented by broken line arrows 204.

In examples, media path 212 includes a variety of guides, rollers, wheels, etc. to achieve handling and routing of media, such as media 202, within and/or through ADF 200, as disclosed herein. In examples, media path 212 routes media, such as media 202, to and/or past an image reader 208, as an example of image reader 126, such that image reader 208 may acquire and/or generate an image of a side or surface of the media.

In one example, media path 212 includes a series of opposing rollers or opposing roller pairs 214 to contact and guide and/or route media, such as media 202, along and/or through media path 212. In one implementation, opposing roller pairs 214 include a pick roller pair 241, a separation roller pair 242, a pre-scan roller pair 243, a post-scan roller pair 244, and an exit roller pair 245. As such, in one example, pick roller pair 241 includes rollers 241a, 241b, separation roller pair 242 includes rollers 242a, 242b, pre-scan roller pair 243 includes rollers 243a, 243b, post-scan roller pair 244 includes rollers 244a, 244b, and exit roller pair 245 includes rollers 245a, 245b. Accordingly, rollers 241a, 242a, 243a, 244a, and 245a contact one side of media in media path 212, and rollers 241b, 242b, 243b, 244b, and 245b contact an opposite side of media in media path 212. In other implementations, media path 212 may include fewer or more opposing roller pairs 214.

In examples, pick roller pair 241 picks media, such as media 202, from input tray 215 and feeds media to media path 212. More specifically, in one implementation, roller 241a of pick roller pair 241 is a driven roller and contacts media, such as media 202, in input tray 215 including, more specifically, a top sheet of media when multiple sheets of media are supported by or within input tray 215. In examples, when multiple sheets of media are supported by or within input tray 215, separation roller pair 242 helps to separate the media and prevent multiple sheets of media from being fed to media path 212. In examples, pre-scan roller pair 243 is positioned upstream or prior to a read or scan area of image reader 208 to guide media to and/or through the read or scan area of image reader 208, and post-scan roller pair 244 is positioned downstream or after the read or scan area of image reader 208 to guide media through and/or from the read or scan area of image reader 208. Furthermore, exit roller pair 245 is positioned toward, near, or at an end of media path 212 to guide media to media tray 216, as an example of an output tray.

Although described as rollers, rollers of opposing roller pairs 214 may include wheels, including star wheels. Although one pick roller pair 241, one separation roller pair 242, one pre-scan roller pair 243, one post-scan roller pair 244, and one exit roller pair 245 is illustrated and described, multiple pick roller pairs 241, multiple separation roller pairs 242, multiple pre-scan roller pairs 243, multiple post-scan roller pairs 244, and/or multiple exit roller pairs 245 may be provided for media path 212.

In one example, to contact and guide and/or route media, such as media 202, along and/or through media path 212, rollers of respective opposing roller pairs 214 are positioned opposite each other such that rollers of respective opposing roller pairs 214 contact each other and form a pinch or nip therebetween. More specifically, in one implementation, rollers 241a, 241b of pick roller pair 241 form a pinch or nip therebetween, rollers 242a, 242b of separation roller pair 242 form a pinch or nip therebetween, rollers 243a, 243b of pre-scan roller pair 243 form a pinch or nip therebetween, rollers 244a, 244b of post-scan roller pair 244 form a pinch or nip therebetween, and rollers 245a, 245b of exit roller pair 245 form a pinch or nip therebetween.

In one implementation, at least one roller of each opposing roller pair 214 is biased, for example, spring-biased, to form the pinch or nip therebetween. For example, regarding pick roller pair 241, in one implementation, roller 241a is biased, for example, spring-biased, toward roller 241b, downward in the orientation illustrated, such that, in use, rollers 241a, 241b form the pinch or nip therebetween. For example, regarding separation roller pair 242, in one implementation, roller 242b is biased, for example, spring-biased, toward roller 242a, upward in the orientation illustrated, such that rollers 242a, 242b form the pinch or nip therebetween. For example, regarding pre-scan roller pair 243, in one implementation, roller 243a is biased, for example, spring-biased, toward roller 243b such that rollers 243a, 243b form the pinch or nip therebetween. For example, regarding post-scan roller pair 244, in one implementation, roller 244a is biased, for example, spring-biased, toward roller 244b such that rollers 244a, 244b form the pinch or nip therebetween. For example, regarding exit roller pair 245, in one implementation, roller 245a is biased, for example, spring-biased, toward roller 245b such that rollers 245a, 245b form the pinch or nip therebetween.

As illustrated in the example of FIGS. 3A and 3B, 4A and 4B, media tray 216 of ADF 200 is moved between a “closed” position and an “open” position. More specifically, in one implementation, media tray 216 is rotated, as represented, for example, by arrow 206, to open media tray 216 and move media tray 216 from the closed position to the open position. Conversely, media tray 216 is rotated, opposite of arrow 206, to close media tray 216 and move media tray 216 from the open position to the closed position.

In examples, opening media tray 216 disengages opposing roller pairs 214 of media path 212 (and closing media tray 216 engages opposing roller pairs 214 of media path 212). More specifically, with media tray 261 in the closed position, as illustrated in the example of FIG. 4A, opposing roller pairs 214 of media path 212 are in a “pinch” position such that respective opposing roller pairs 214 engage (e.g., contact) each other. As such, opposing roller pairs 214 may guide and/or route media through media path 212. However, with media tray 216 in the open position, as illustrated in the example of FIG. 4B, opposing roller pairs 214 of media path 212 are in a “de-pinch” position such that respective opposing roller pairs 214 are disengaged (e.g., out of contact, spaced, separated) from each other.

In one implementation, media tray 216 supports roller 241a of pick roller pair 241, supports roller 242a of separation roller pair 242, and supports roller 243a of pre-scan roller pair 243, such that, when media tray 216 is opened (e.g., rotated), media tray 216 disengages roller 241a of pick roller pair 241 from roller 241b of pick roller pair 241, disengages roller 242a of separation roller pair 242 from roller 242b of separation roller pair 242, and disengages roller 243a of pre-scan roller pair 243 from roller 243b of pre-scan roller pair 243. As such, respective rollers of pick roller pair 241, separation roller pair 242, and pre-scan roller pair 243 are “de-pinched.”

In one implementation, ADF 200 includes a linkage 218 extended between or operatively connected or coupled to media tray 216 and roller 244a of post-scan roller pair 244 and roller 245a of exit roller pair 245. In examples, when media tray 216 is opened (e.g., rotated), media tray 216 moves, actuates or operates linkage 218. As such, movement, actuation or operation of linkage 218 disengages roller 244a of post-scan roller pair 244 from roller 244b of post-scan roller pair 244, and disengages roller 245a of exit roller pair 245 from roller 245b of exit roller pair 245.

In one example, linkage 218 includes a cord, cable, strap, or other flexible element extended between or operatively connected or coupled to media tray 216 and roller 244a of post-scan roller pair 244 and roller 245a of exit roller pair 245. In one implementation, when media tray 216 is opened (e.g., rotated), media tray 216 pulls linkage 218, as represented by arrows 222, such that linkage 218 pulls roller 244a of post-scan roller pair 244 away from roller 244b of post-scan roller pair 244 (in a direction opposite the bias force applied to roller 244a), and pulls roller 245a of exit roller pair 245 away from roller 245b of exit roller pair 245 (in a direction opposite the bias force applied to roller 245a). As such, respective rollers of post-scan roller pair 244 and exit roller pair 245 are “de-pinched.”

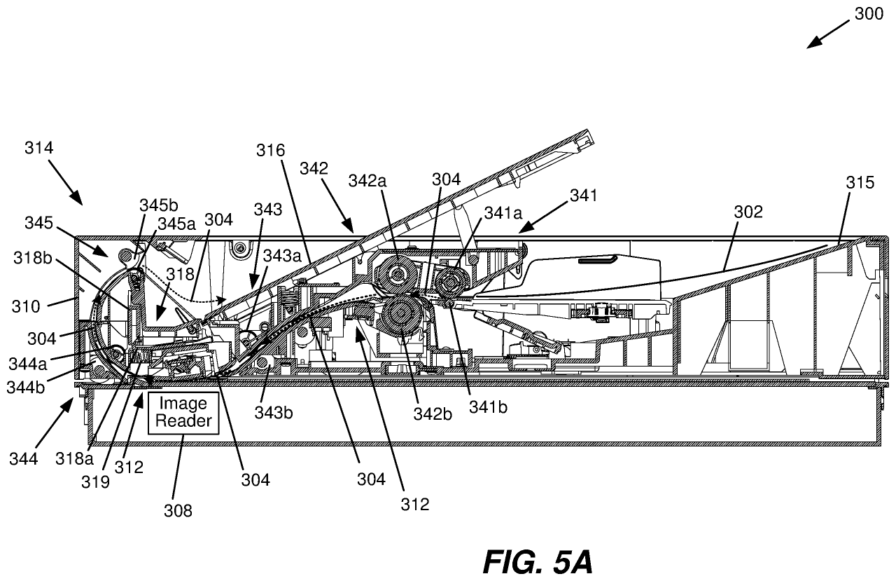

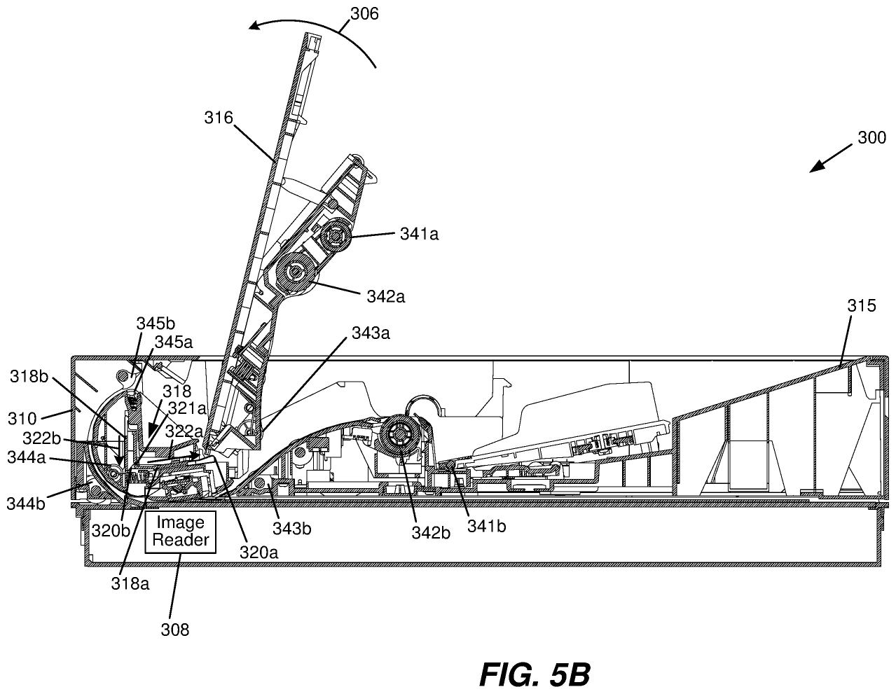

FIGS. 5A and 5B are cross-sectional views illustrating another example of an automatic document feeder (ADF) 300, as an example of ADF 10, 130, including opening of a media tray 316 of ADF 300, as an example of media tray 16, 136, and disengagement of opposing roller pairs 314 of ADF 300, as an example of opposing roller pair 14, and disengageable rollers 134, with the opening of media tray 316. Similar to media tray 216 of ADF 200, media tray 316 is rotated to be opened, as represented, for example, by arrow 306 and illustrated in the example of FIG. 5B, such that media tray 316 disengages a roller of opposing roller pair 314 from another roller of opposing roller pair 314 when media tray 316 is rotated.

Similar to ADF 200, ADF 300 includes a housing 310, media tray 316 supported by housing 310, and a media path 312, as an example of media path 12, 132, within housing 310 to route media through ADF 300, such as media 302, as an example of media 2, 128. In addition, ADF 300 includes an input tray 315 that supports and supplies media, such as media 302, for input to ADF 300. As such, media 302 may be routed from input tray 315 to media tray 316 along media path 312, as represented by broken line arrows 304. In examples, media path 312 routes media, such as media 302, to and/or past an image reader 308, as an example of image reader 126, such that image reader 308 may acquire and/or generate an image of a side or surface of the media.

Similar to media path 212 of ADF 200, media path 312 includes a series of opposing rollers or opposing roller pairs 314 to contact and guide and/or route media, such as media 302, along and/or through media path 312. In one implementation, similar to opposing roller pairs 214, opposing roller pairs 314 include a pick roller pair 341, a separation roller pair 342, a pre-scan roller pair 343, a post-scan roller pair 344, and an exit roller pair 345. As such, in one example, pick roller pair 341 includes rollers 341a, 341b, separation roller pair 342 includes rollers 342a, 342b, pre-scan roller pair 343 includes rollers 343a, 343b, post-scan roller pair 344 includes rollers 344a, 344b, and exit roller pair 345 includes rollers 345a, 345b.

In examples, similar to opening media tray 216, opening media tray 316 disengages opposing roller pairs 314 of media path 312 (and closing media tray 316 engages opposing roller pairs 314 of media path 312). More specifically, with media tray 361 in the closed position, as illustrated in the example of FIG. 5A, opposing roller pairs 314 of media path 312 are in a “pinch” position such that respective opposing roller pairs 314 engage (e.g., contact) each other. As such, opposing roller pairs 314 may guide and/or route media through media path 312. However, with media tray 316 in the open position, as illustrated in the example of FIG. 5B, opposing roller pairs 314 of media path 312 are in a “de-pinch” position such that respective opposing roller pairs 314 are disengaged (e.g., out of contact, spaced, separated) from each other.

In one implementation, similar to media tray 216, media tray 316 supports roller 341a of pick roller pair 341, supports roller 342a of separation roller pair 342, and supports roller 343a of pre-scan roller pair 343, such that, when media tray 316 is opened (e.g., rotated), media tray 316 disengages roller 341a of pick roller pair 341 from roller 341b of pick roller pair 341, disengages roller 342a of separation roller pair 342 from roller 342b of separation roller pair 342, and disengages roller 343a of pre-scan roller pair 343 from roller 343b of pre-scan roller pair 343. As such, respective rollers of pick roller pair 341, separation roller pair 342, and pre-scan roller pair 343 are “de-pinched.”

In the example of FIGS. 5A and 5B, rather than linkage 218, ADF 300 includes a linkage 318. Similar to linkage 218, linkage 318 is extended between or operatively connected or coupled to media tray 316 and roller 344a of post-scan roller pair 344 and roller 345a of exit roller pair 345. In examples, when media tray 316 is opened (e.g., rotated), media tray 316 moves, actuates or operates linkage 318. As such, movement, actuation or operation of linkage 318 disengages roller 344a of post-scan roller pair 344 from roller 344b of post-scan roller pair 344, and disengages roller 345a of exit roller pair 345 from roller 345b of exit roller pair 345.

In one example, linkage 318 includes a slider or element 318a extended between or operatively connected or coupled to media tray 316 (when media tray 316 is closed) and roller 344a of post-scan roller pair 344, and a slider or element 318b extended between or operatively connected or coupled to slider 318a and roller 345a of exit roller pair 345. In one implementation, slider or element 318a is biased, for example, spring-biased by a spring 319, and includes a feature or surface 320a that contacts (or is contacted by) media tray 316 (when media tray 316 is closed), and a feature or surface 321a that contacts (or is contacted by) slider or element 318b. In addition, slider or element 318b is biased, for example, spring-biased, and includes a feature or surface 320b that contacts (or is contacted by) feature or surface 321a of slider or element 318a.

As such, when media tray 316 is opened (e.g., rotated), media tray 316 releases or enables slider or element 318a to slide (in a direction of the bias force applied to slider or element 318a), as represented by arrow 322a, such that roller 344a of post-scan roller pair 344 is released or permitted to separate or move away from roller 344b of post-scan roller pair 344 (i.e., move in a direction opposite the bias force applied to roller 344a). In addition, release or sliding of slider or element 318a, releases or enables slider or element 318b to slide (in a direction of the bias force applied to slider or element 318b), as represented by arrow 322b, such that roller 345a of exit roller pair 345 is released or permitted to separate or move away from roller 345b of exit roller pair 345 (i.e., move in a direction opposite the bias force applied to roller 345a). As such, respective rollers of post-scan roller pair 344 and exit roller pair 345 are “de-pinched.”

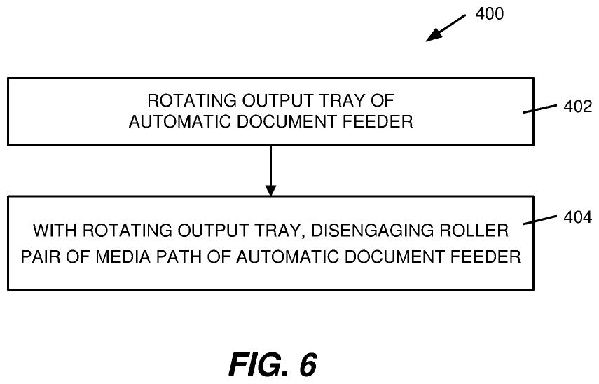

FIG. 6 is a flow diagram illustrating an example of a method 400 of disengaging rollers of an automatic document feeder, such as automatic document feeder 10, 130, 200, 300, as illustrated in the examples of FIGS. 1A and 1B, FIG. 2, FIGS. 3A and 3B, 4A and 4B, FIGS. 5A and 5B, respectively.

At 402, method 400 includes rotating an output tray of the automatic document feeder, such as rotating media tray 16, 216, 316 of automatic document feeder 10, 200, 300, as illustrated in the examples of FIGS. 1A and 1B, FIGS. 3A and 3B, 4A and 4B, FIGS. 5A and 5B, respectively.

At 404, method 400 includes, with the rotating of the output tray, disengaging a roller pair of a media path of the automatic document feeder, such as disengaging opposing roller pairs 14 of media path 12 of automatic document feeder 10, disengaging opposing roller pairs 214 of media path 212 of automatic document feeder 200, disengaging opposing roller pairs 314 of media path 312 of automatic document feeder 300, as illustrated in the examples of FIG. 1B, FIGS. 3B, 4B, FIG. 5B, respectively.

In one example, disengaging the roller pair at 404, includes rotating a first roller of the roller pair away from a second roller of the roller pair, with the first roller supported by the output tray, such as rotating rollers 141a, 142a, 143a of pick roller pair 141, separation roller pair 142, pre-scan roller pair 143 away from rollers 141b, 142b, 143b of pick roller pair 141, separation roller pair 142, pre-scan roller pair 143, with rollers 141a, 142a, 143a supported by media tray 16, rotating rollers 241a, 242a, 243a of pick roller pair 241, separation roller pair 242, pre-scan roller pair 243 away from rollers 241b, 242b, 243b of pick roller pair 241, separation roller pair 242, pre-scan roller pair 243, with rollers 241a, 242a, 243a supported by media tray 216, rotating rollers 341a, 342a, 343a of pick roller pair 341, separation roller pair 342, pre-scan roller pair 343 away from rollers 341b, 342b, 343b of pick roller pair 341, separation roller pair 342, pre-scan roller pair 343, with rollers 341a, 342a, 343a supported by media tray 316, as illustrated in the examples of FIG. 1B, FIGS. 3B, 4B, FIG. 5B, respectively.

In one example, disengaging the roller pair at 404, includes spacing a first roller of the roller pair from a second roller of the roller pair with a linkage operatively coupled to the output tray and the first roller, such as spacing rollers 144a, 145a of post-scan roller pair 144, exit roller pair 145 from rollers 144b, 145b of post-scan roller pair 144, exit roller pair 145 with linkage 18, spacing rollers 244a, 245a of post-scan roller pair 244, exit roller pair 245 from rollers 244b, 245b of post-scan roller pair 244, exit roller pair 245 with linkage 218, spacing rollers 344a, 345a of post-scan roller pair 344, exit roller pair 345 from rollers 344b, 345b of post-scan roller pair 344, exit roller pair 345 with linkage 318, as illustrated in the examples of FIG. 1B, FIGS. 3B, 4B, FIG. 5B, respectively.

With an automatic document feeder and method of disengaging rollers of an automatic document feeder, as disclosed herein, rollers of the media path are automatically disengaged (e.g., de-pinched) by opening of the output tray. In examples, multiple opposing roller pairs, including a pick roller pair, a separation roller pair, a pre-scan roller pair, a post-scan roller pair, and an exit roller pair, are automatically disengaged (e.g., de-pinched) by opening of the output tray. Disengaging (e.g., de-pinching) rollers of the media path, as disclosed herein, may improve user experience with the automatic document feeder, as the user can access the rollers of the media path without having to open additional or multiple doors or compartments.

Although specific examples have been illustrated and described herein, it will be appreciated by those of ordinary skill in the art that a variety of alternate and/or equivalent implementations may be substituted for the specific examples shown and described without departing from the scope of the present disclosure. This application is intended to cover any adaptations or variations of the specific examples discussed herein.

1. An automatic document feeder, comprising:
a media path to route media through the automatic document feeder;
an opposing roller pair to route media along the media path; and
a media tray to receive the media from the media path,
the media tray to be opened, and the opposing roller pair to be disengaged when the media tray is opened.

2. The automatic document feeder of claim 1, the media tray to support a roller of the opposing roller pair, the media tray to be rotated to be opened, and the media tray to disengage the roller of the opposing roller pair from another roller of the opposing roller pair when the media tray is rotated.

3. The automatic document feeder of claim 1, further comprising:
a linkage extended between the media tray and a roller of the opposing roller pair, the media tray to be rotated to be opened, and the linkage to disengage the roller of the opposing roller pair from another roller of the opposing roller pair when the media tray is rotated.

4. The automatic document feeder of claim 1, wherein:
the opposing roller pair comprises a pick roller pair or a separation roller pair.

5. The automatic document feeder of claim 1, wherein:
the opposing roller pair comprises a pre-scan roller pair.

6. The automatic document feeder of claim 1, wherein:
the opposing roller pair comprises a post-scan roller pair.

7. The automatic document feeder of claim 1, wherein:
the opposing roller pair comprises an exit roller pair.

8. An automatic document feeder, comprising:
an input tray to support media input to the automatic document feeder;
an output tray to support media output from the automatic document feeder; and
a media path to route media from the input tray to the output tray,
the media path including a first roller and a second roller forming a nip therebetween, and
with rotation of the output tray, the first roller to move away from the second roller to open the nip.

9. The automatic document feeder of claim 8, the first roller supported by the output tray, and with rotation of the output tray, the first roller to rotate away from the second roller to open the nip.

10. The automatic document feeder of claim 9, the first roller and the second roller comprising pick rollers, separation rollers, or pre-scan rollers.

11. The automatic document feeder of claim 8, further comprising:
a linkage extended between the output tray and the first roller,
with rotation of the output tray, the linkage to separate the first roller from the second roller to open the nip.

12. The automatic document feeder of claim 11, the first roller and the second roller comprising post-scan rollers or exit rollers.

13. A method of disengaging rollers of an automatic document feeder, comprising:
rotating an output tray of the automatic document feeder; and
with the rotating of the output tray, disengaging a roller pair of a media path of the automatic document feeder.

14. The method of claim 13, wherein:
disengaging the roller pair comprises rotating a first roller of the roller pair away from a second roller of the roller pair, the first roller supported by the output tray, the first roller engaging the second roller before the disengaging.

15. The method of claim 13, wherein:
disengaging the roller pair comprises spacing a first roller of the roller pair from a second roller of the roller pair with a linkage operatively coupled to the output tray and the first roller, the first roller engaging the second roller before the disengaging.
